(19) United States
(12) Patent Application Publication
(10) Pub. No.: US 2008/0209326 A1
(43) Pub. Date: Aug. 28, 2008

(54) System And Method For Preparing A Video Presentation

(76) Inventors: Richard W. Stallings, Plymouth, MI (US); Scott Russell, Belleville, MI (US); Mark Stallings, Plymouth, MI (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/037,382

(22) Filed: Feb. 26, 2008

Related U.S. Application Data
(60) Provisional application No. 60/891,600, filed on Feb. 26, 2007.

(51) Int. Cl. G06F 3/00

(52) U.S. Cl. 715/719

(57) ABSTRACT

A process, method and system for preparation of a video presentation including providing video content, selecting at least one presentation template from a library of presentation templates and assembling the video content and the at least one presentation template to provide the final video presentation.

### CROSS-REFERENCE TO RELATED INVENTIONS

This application claims the benefit of provisional application No. 60/891,600, filed Feb. 26, 2007, the disclosure of which is hereby incorporated by reference herein.

### BACKGROUND OF THE INVENTION

1. Field of the Invention

The invention generally relates to video presentations, and more particularly to a modularized system for preparing video presentations based on libraries of templates.

2. Description of the Background Art

The production of video content for use in connection with sales presentations, promotional information, technical seminars, and the like, is often an expensive and time consuming endeavor. The process may include numerous iterations of storyboarding, by which the content, flow, and graphics of the presentation are developed. Once the final concepts, and the look and feel have been determined, the video content must be recorded. Additionally, custom recording sets and graphics, for example, must be designed and manufactured. Further, once the video content has been recorded, the recording must be edited for content and to incorporate title sequences, closing sequences, etc., which must often also be custom designed. In addition to being time consuming and often expensive, the production of video presentations may also require a great deal of technical expertise and overhead, in terms of the necessary video production and editing equipment.

Therefore, it is an object of this invention to provide an improvement which overcomes the aforementioned inadequacies of the prior art devices and provides an improvement which is a significant contribution to the advancement of the video presentation art.

Another object of this invention is to provide an system and method for preparing a video presentation including the steps of providing video content and selecting presentation templates, and then assembling the video content and the presentation templates to provide the final video presentation.

Another object of this invention is to provide an system and method for preparing a video presentation in which providing video content may comprise generating a video or audio-video recording of the desired video content.

Another object of this invention is to provide an system and method for preparing a video presentation in which selecting presentation templates may include selecting templates from a library.

Another object of this invention is to provide an system and method for preparing a video presentation with the templates in the template library including a preformatted arrangement of graphical and/or functional elements that may be used as is, or may be modified and/or customized.

Another object of this invention is to provide an system and method for preparing a video presentation modularly, composed of an introduction module, a video content module and an exit module, with the library of templates being correspondingly modular in nature such that one or more templates may be associated with each module of the video presentation.

Another object of this invention is to provide an system and method for preparing a video presentation wherein the video content has been recorded using a “green screen” allowing the subject to be recorded in front of the green screen to then be isolated from the green screen background and to then be transplanted onto a different background.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an system and method for preparing a video presentation including the steps of providing video content, selecting presentation templates, and then assembling the video content and the presentation templates to provide the final video presentation. Providing video content may comprise generating a video or audio-video recording of the desired video content. Selecting presentation templates may include selecting templates from a library, which may include numerous different available templates. Each template in the template library may include a preformatted arrangement of graphical and/or functional elements that may be used as is, or may be modified and/or customized.

The video presentation may be of a modular arrangement composed of an introduction module, a video content module and an exit module. The library of templates may be correspondingly modular in nature such that one or more templates may be associated with each module of the video presentation.

According to one embodiment, the video content may have been recorded using a “green screen” allow the subject to be recorded in front of the green screen to then be isolated from the green screen background and to then be transplanted onto a different background. As such, selecting a video content module template may also include selecting a background upon which the subject of the video recording may be superimposed.

In its modular format, assembling the video presentation may include customizing the selected module templates for each module.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

Features and advantages of the disclosure are set forth by way of the description of embodiments consistent therewith, which description should be considered along with the accompanying drawings, wherein:

FIG. 1 diagrammatically depicts a video presentation;

FIG. 2 is a flowchart of a video presentation preparation process;

FIG. 3 diagrammatically depicts embodiments of exemplary introduction module templates;

FIG. 4 diagrammatically depicts embodiments of exemplary video content module templates; and

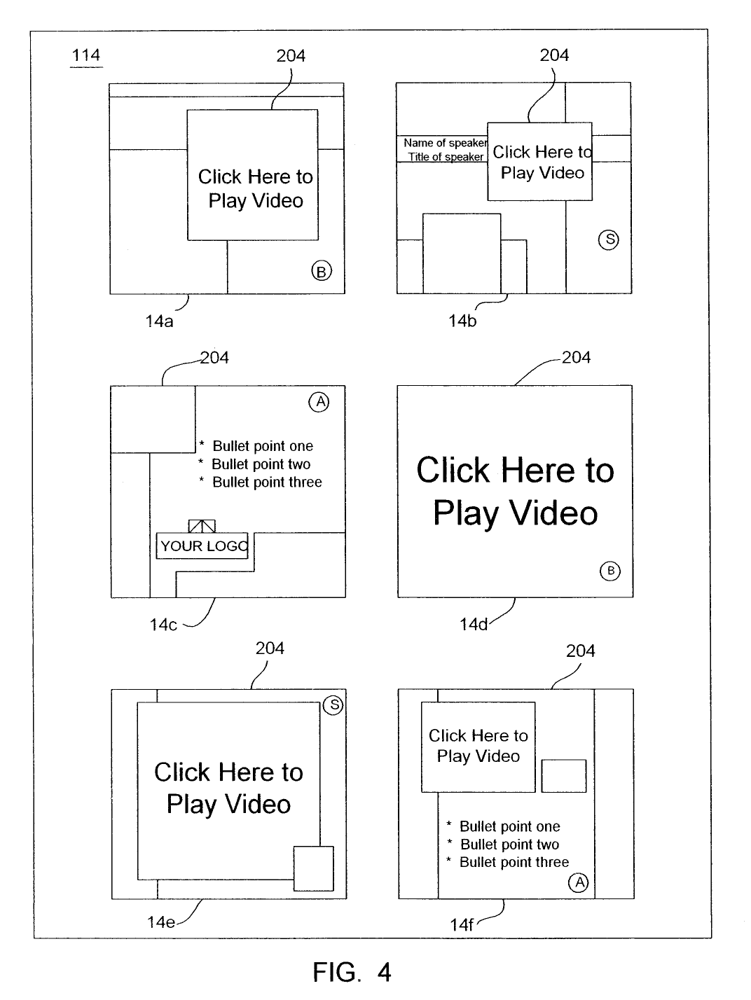

FIG. 5 diagrammatically depicts embodiments of exemplary exit module templates.

Similar reference characters refer to similar parts throughout the several views of the drawings.

### DETAILED DESCRIPTION OF THE PREFERRED EMBODIMENT

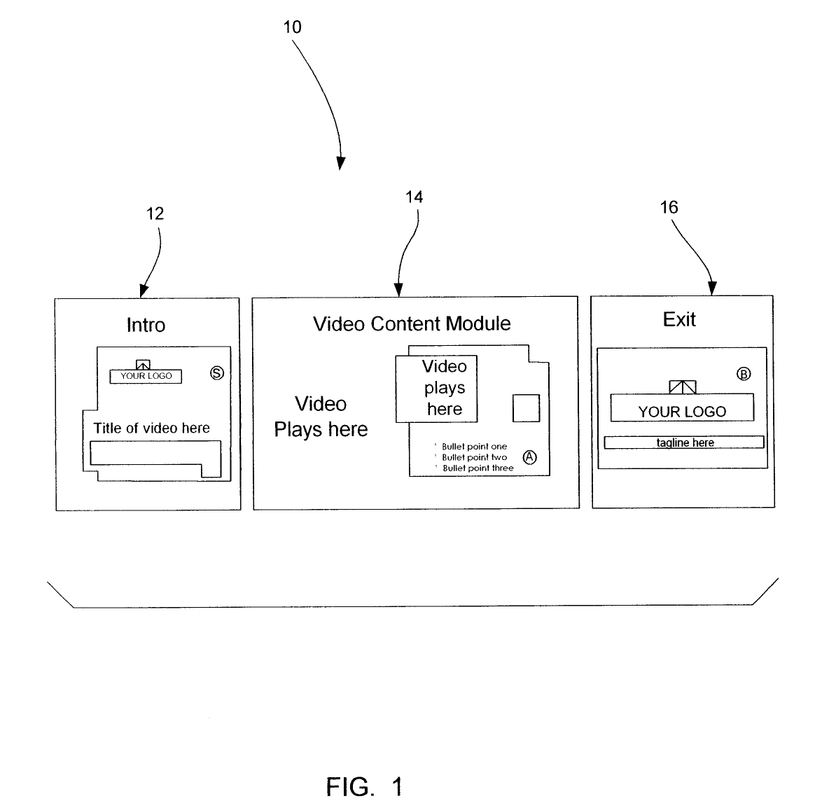

With reference to FIG. 1, a video presentation 10 may generally be a modular arrangement composed of an introduction module 12, a video content module 14, and an exit module 16. Video presentation 10 may, for example, be rendered as a continuous video, or an audio/video sequence, for example. Of course, modules 12, 14, 16 may be rendered individually or in varying orders of progression. Introduction module 12 may include introductory subject matter, for example, but not limited to, titles, and provider information. Video content module 14 may include the bulk of the video content of video presentation 10, including, but not limited to, acted or spoken material, and animated features. Video presentation 10 may include one or more video content modules that may differ from one another and may be linked, e.g., by transitional modules (not shown). Exit module 16 may included features including, but not limited to, summary information, credits, and contact information. Video presentation 10 may also include transition modules (not shown) linking or segueing between one or more of introduction module 12, video content module 14, and exit module 16.

Video presentation 10 may take the form of, or be used in connection with, any variety of variety of video presentations, or multimedia works. For example, video presentation 10 may be included as part of a sales presentation, e.g., a prerecorded sales presentation distributed to potential purchasers, or part of an interactive (e.g., web-based) presentation. Similarly, video presentation 10 may be included as part of a sales or technical lecture, e.g., as an embedded component of a PowerPoint™ presentation, as a standalone video presentation, etc. In the previous example, a speaker who may not actually be present at the lecture may be able to provide at least a portion of the lecture content, e.g., via video presentation 10.

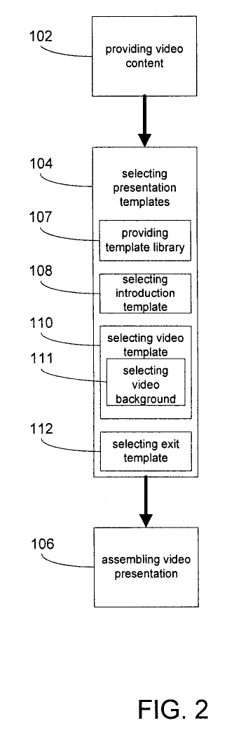

Referring also to FIG. 2, a process 100 for preparing a video presentation may generally include providing 102 video content, selecting 104 presentation templates, and assembling 106 the video content and the presentation templates to provide the final video presentation. Of course providing 102 the video content and selecting 104 the presentation templates need not be sequential operations. Similarly, the order of providing 102 video content and selecting 104 presentation templates is also unimportant.

Providing 102 video content may include generating a video or audio-video recording of the desired video content. For example, in the context of a sales presentation for a mutual fund investment opportunity, the video content may include an individual providing a presentation regarding the attributes of the fund, such as the past performance of the fund, projected market trends, etc. The recording may be a professionally produced recording, shot in a studio, etc. Alternatively, the recording may be accomplished via amateur production, e.g., using a web camera, digital video camera, etc.

In video presentation 10, including various modules such as introduction module 12, video content module 14, and exit module 16, selecting 104 presentation templates may include selecting templates for one or more of the several modules. Each module of video presentation 10 may include a separate template. Alternatively, a common template may be used for each module of video presentation 10. The template for each module of video presentation 10 may be selected from a library, which may include numerous different available templates for each module.

Continuing with the above-stated example, selecting 104 presentation templates may include providing 107 a library of module templates. The library of module templates may be maintained, for example, on a storage device (not shown), which may be associated with a computer having one or more processors and one or more associated memories (not shown). The library of module templates may include one or more templates associated with each module of the video presentation 10. Each template in the template library may include a preformatted arrangement of graphical and/or functional elements that may be used as is, or may be modified and/or customized. Examples of templates are detailed below.

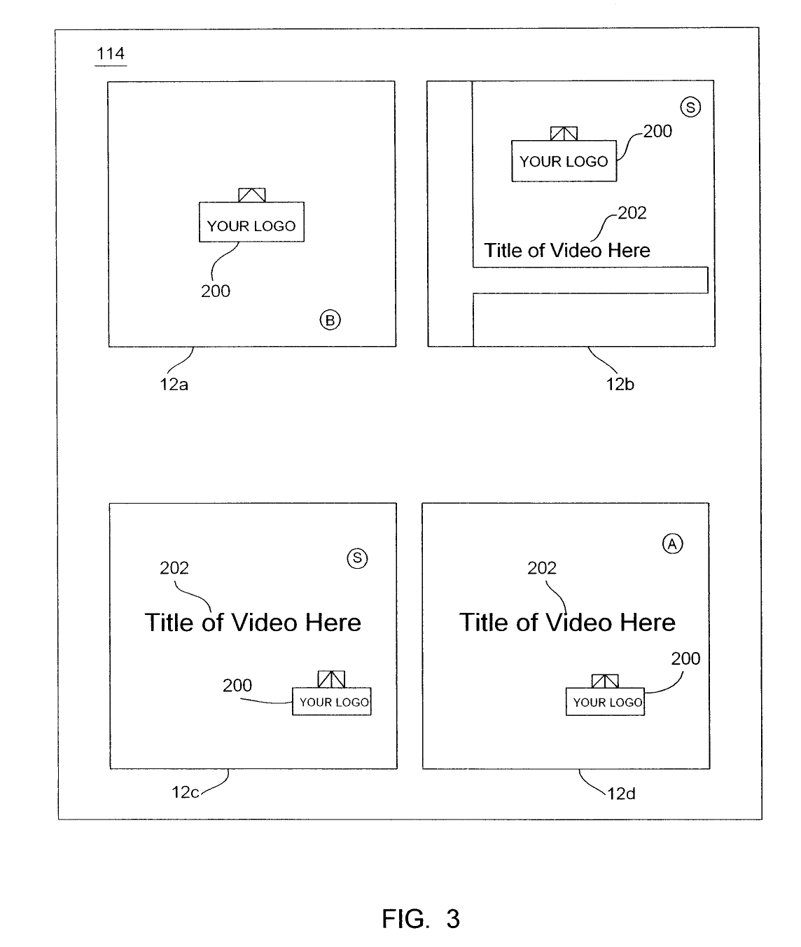

Selecting 104 presentation templates may include selecting 108 an introduction module template. With additional reference to FIG. 3, the template library 114 may include one or more introduction module templates 12a-12d, features of which may be incorporated into introduction module 12 of video presentation 10, i.e., introduction 12 may be based, at least in part, upon one or more of templates 12a-12d. Introduction module templates 12a-12d may include a variety of graphic formats, and may allow a user to customize the templates, e.g., to include a company logo 200, title 202 of the video, various backgrounds, etc. Additionally, in various embodiments, introduction module templates 12a-12d may include static and/or dynamic features. For example, one or more of logo 200, title 202, background, etc. may itself be a video component, or an animated feature, for example.

Template library 114 may also include one or more video content module templates 14a-14f. Selecting 104 presentation templates may include selecting 110 one or more video content module templates 14a-14f for video content module 14. In an embodiment of a video presentation including multiple video modules, each video module may use the same template, or a different template. As with the introduction module templates, video content module templates 14a-14f may include a variety of graphic features, and may include a video playback box 204, as well as other images, text, designs, backgrounds, etc. The video content, e.g., which may be rendered in video playback box 204, may be an embedded feature video content module 14. The video content may play in the video content module template automatically, or may require a request from a viewer of video presentation 10, e.g., by selecting video playback box 204 using a screen pointer (not shown), e.g., controlled by a mouse (not shown), etc.

According to one embodiment, the video content may have been recorded using a “green screen.” As is known in the art, “green screen” video recording techniques may allow, e.g., the subject recorded in front of the green screen to be isolated from the green screen background and to be transplanted onto a different background. For example, a recording of a speaker, that was video recorded using green screen editing techniques, may be edited to place the speaker in front of a cityscape, etc. As such, selecting 110 video content module template may also include selecting 111a background, e.g., upon which the subject of the video recording may be superimposed.

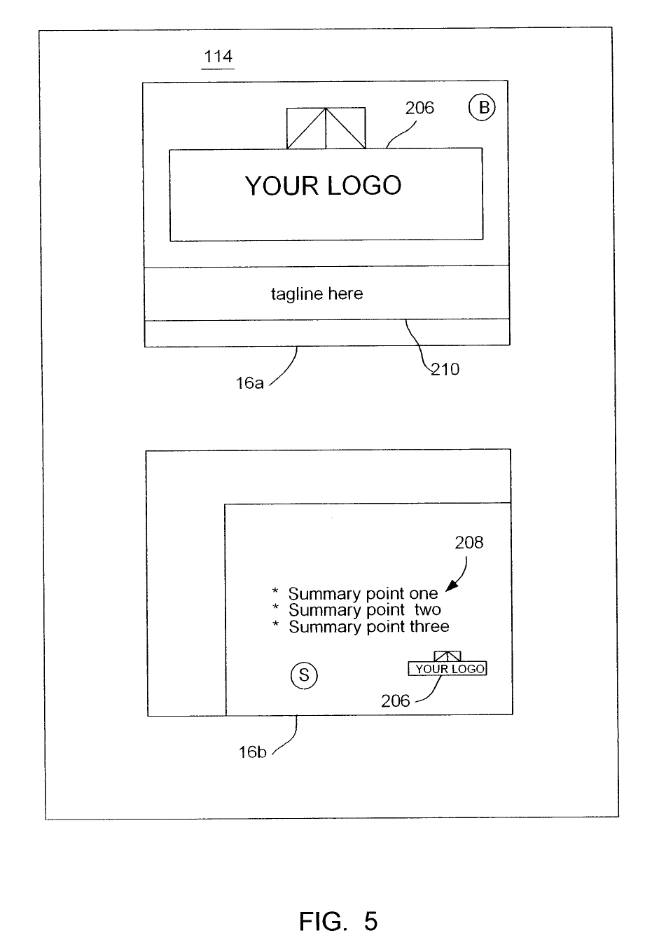

With reference also to FIG. 5, the template library 114 may also include one or more exit module templates 16a-16b. Process 100 may also include selecting 112 one of exit module templates 16a-16b. Exit module templates 16a-16b may include various information, e.g., a company logo 206, video summary points 208, taglines 210, video credits, sales information, etc.

Assembling 106 the video presentation may include customizing the selected module templates 12a-12d, 14a-14f, 16a-16b. For example, company logos, selected graphics, as well as the provided video content may be incorporated and/or embedded into the various selected module templates to create the associated modules 12, 14, 16. Introduction module 12, video content module 14, and exit module 16 may be linked, e.g., to be rendered in a desired sequence and/or at a desired pace, to provide video presentation 10. A completed video presentation may be recorded as a video sequence, e.g., to provide a single media file, or may be provided as individual media files, e.g., linked for rendering in the desired sequence, at the desired pace, etc.

Process 100 for providing video presentation 10 may be provided in a number of formats. For example, in one implementation, process 100 may be provided as a service. For example, a third party wishing to make a video presentation may interact through a video production entity, which may, for example, record video content for the third party, access, and/or provide the third party with access to, template library 114, customize selected templates, assemble video content and templates, etc.

In one example, the third party may provide the video production entity with a script for the desired video content, e.g., in the form of a hardcopy or electronic document. The video production entity may along with, or in association with, the third party record video content based on the script provided by the third party. Alternatively, the third party may record the video content on their own, and provide the recorded video content to the video production entity. The video production entity may provide the third party with access to the module library, by which the third party may select module templates for the introduction module, video content module, and the exit module. Based, at least in part, upon input from the third party, the video production entity may customize the selected templates, e.g., with company information, titles, background selections, provided by the third party. The video production entity may then assemble the customized templates and the recorded video content to provide the third party with a finished video presentation, which may be used as a stand-alone presentation, incorporated into an electronic document (e.g., a PowerPoint™ presentation), etc.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A process for preparing a video presentation: comprising:
providing video content;
selecting at least one presentation template from a library of presentation templates; and
assembling the video content and the at least one presentation template.

2. The process of claim 1, wherein selecting at least one presentation template comprises selecting at least one of an introduction module template, a video content module template, or an exit module template.

3. A method for preparing a video presentation including the steps of:
providing video content,
selecting presentation templates, and
assembling the video content and the presentation templates to provide the final video presentation.

4. The method as set forth in claim 3, wherein the step of providing video content comprises generating a video or audio-video recording of the desired video content.

5. The method as set forth in claim 3, wherein the step of selecting presentation templates include selecting templates from a library.

6. The method as set forth in claim 5, wherein the templates in the template library include a preformatted arrangement of graphical and/or functional elements.

7. The method as set forth in claim 6, wherein the templates are used as is, are modified or are customized.

8. The method as set forth in claim 6, wherein the step of preparing the video presentation comprises preparing a video presentation modularly composed of an introduction module, a video content module and an exit module.

9. The method as set forth in claim 8, wherein the library of templates are correspondingly modular in nature such that one or more templates are associated with each module of the video presentation.

10. The method as set forth in claim 3, wherein the step of providing video content comprises a recording using a “green screen” allowing the subject to be recorded in front of the green screen to then be isolated from the green screen background and to then be transplanted onto a different background.

11. A system for preparing a video presentation comprising:
video content;
at least one presentation template from a library of presentation templates; and
an assembly of the video content and the at least one presentation template.

12. The system of claim 10, wherein selecting at least one presentation template comprises selecting at least one of an introduction module template, a video content module template, or an exit module template.

13. A system for preparing a video presentation, comprising in combination:
video content,
at least one presentation template, and
an assembly of the video content and the presentation templates to provide the final video presentation.

14. The system of claim 13, wherein the video content comprises a video or audio-video recording of the desired video content.

15. The system of claim 13, wherein the presentation template include templates selected from a library.

16. The system of claim 15, wherein the templates in the template library include a preformatted arrangement of graphical and/or functional elements.

17. The system of claim 16, wherein the templates are used as is, are modified or are customized.

18. The system of claim 15, wherein the video presentation comprises a modular video presentation composed of an introduction module, a video content module and an exit module.

19. The system of claim 18, wherein the library of templates are correspondingly modular in nature such that one or more templates are associated with each module of the video presentation.

20. The system of claim 13, wherein the video content comprises a recording using a “green screen” allowing the subject to be recorded in front of the green screen to then be isolated from the green screen background and to then be transplanted onto a different background.
